(19) United States
(12) Patent Application Publication
(10) Pub. No.: US 2026/0335914 A1
(43) Pub. Date: Oct. 29, 2026

(54) MATERIAL DISTRIBUTION SYSTEM FOR A SPREADING MACHINE, SPREADING MACHINE AND METHOD FOR DISTRIBUTING SPREADING MATERIAL

(71) Applicant: AMAZONEN-WERKE H.DREYER SE & CO., KG, Hasbergen (DE)

(72) Inventors: Daniel MERTENS, Oldenburg (DE); Felix WARNS, Berne (DE); Thomas WEN, Stuhr (DE)

(21) Appl. No.: 19/104,950

(22) PCT Filed: Aug. 9, 2023
(86) PCT No.: PCT/EP2023/072047

§ 371 Date: Feb. 19, 2025

(30) Foreign Application Priority Data
Aug. 23, 2022 (DE) 10 2022 121 240.8

(51) Int. Cl. B05B 7/14; A01C 15/04; B05B 13/00

(52) U.S. Cl. CPC B05B 7/1477; A01C 15/04; B05B 13/005

(57) ABSTRACT

The invention relates to a material distribution system (12) for an agricultural spreading machine (10), with a main distribution unit (20) for generating a plurality of conveying air flows (50) loaded with spreading material (48), a plurality of dosing systems (28), each of which is adapted to be pneumatically operated by means of a dosing air flow (52) and to dose the spreading material (48) conveyed into the dosing system (28) via one of the conveying air flows (50) and one or more blowers (36, 40), which are set up to generate the conveying air having a conveying air pressure (pF) for the conveying air flows (50) and the dosing air having a dosing air pressure (pD) for the dosing air flows (52).

The invention relates to a material distribution system according to the general term of claim 1, a spreading machine according to the general term of claim 10 and a method for distributing spreading material according to the general term of claim 11.

Material distribution systems of modern agricultural spreading machines can be designed as so-called nursing systems, in which a main distribution unit is used to generate several conveying air flows loaded with spreading material. The conveying air flows are then fed to several material receiving units of the spreading machine, whereby the material receiving units can each be assigned to a dosing system or be part of a dosing system. The spreading material received via the material receiving units is then dosed in dosing systems so that the dosed spreading material can be deposited on the agricultural area via depositing devices. The dosing systems can be operated pneumatically with a dosing air flow.

Corresponding material distribution systems usually have one or more blowers to provide the conveying air for the conveying air flows and the dosing air for the dosing air flows. The conveying air pressure of the conveying air flows and the dosing air pressure of the dosing air flows usually differ from each other during operation of the material distribution system.

It is known from the publication EP 3 987 904 A 1 that the suitable pressure differences between conveying air pressure and dosing air pressure depend on the type of material to be distributed. Consequently, it is advantageous to generate conveying air flows and dosing air flows in which the conveying air pressure and the dosing air pressure have a constant pressure difference to each other that is specific to the material to be distributed.

However, maintaining a constant pressure difference between the conveying air pressure and the dosing air pressure specific to the material to be distributed leads to problems in some operating situations of the material distribution system. In this context, for example, the emptying of a storage container for the spreading material or the emptying of the dosing systems should be mentioned. In both situations, maintaining a predetermined pressure difference between the conveying air pressure and the dosing air pressure can lead to a blockage at the dosing systems, which impairs or even interrupts the dosing process.

The task underlying the invention is therefore to enable the air pressure control in pneumatic material distribution systems to be adjusted as required.

The problem is solved by a material distribution system of the type mentioned at the beginning, wherein the material distribution system according to the invention has a control device which is set up to adjust the conveying air pressure during a spreading process in several different operating modes of the material distribution system in a mode-specific manner as a function of the dosing air pressure.

The control device is preferably set up to adjust the conveying air pressure during the spreading process in the respective operating modes of the material distribution system in such a way that a predetermined mode-specific pressure difference to the dosing air pressure is maintained in the respective operating modes. The mode-specific pressure differences, which are maintained in the respective operating modes, differ from one another. For example, the control device can be set up to set a first pressure difference between the conveying air pressure and the dosing air pressure in a first operating situation during the spreading process and to set a second pressure difference between the conveying air pressure and the dosing air pressure in a second operating situation during the spreading process.

The dosing air pressure serves as a reference variable in each of the several operating modes. The dosing air pressure can change for various reasons during the spreading process, for example because energy is to be saved, because temporary changes of the spreading material are detected or because the dosing systems of the material distribution system are to be emptied. The dosing air pressure can be specified by operator input. Alternatively, the control unit can determine a preset value for the dosing air pressure to be maintained. In the different operating modes, different mode-specific pressure differences between the dosing air pressure and the conveying air pressure can be advantageous.

Preferably, several mode-specific pressure differences are assigned to a dispensing material and/or a dispensing material type.

The spreading material can, for example, be grainy or granular spreading material, such as seed. The material distribution system can have a line system for the conveying air flows, via which the spreading material is conveyed from the main distribution unit to the dosing systems. The conveying air pressure is preferably set in the respective operating modes of the material distribution system as part of a regulation, so that the control device can be designed as a regulating device.

In a preferred further development, the material distribution system according to the invention can be operated in a continuous operating mode, in which the dosing systems are supplied with spreading material from the main distribution unit, and in an emptying mode, in which the supply of spreading material to the dosing systems from the main distribution unit is reduced or interrupted in comparison to the continuous operating mode. The control device is preferably set up to adjust the conveying air pressure in such a way that mode-specific pressure differences from the dosing pressure are maintained in the continuous operating mode and emptying mode. The control device is preferably set up to adjust the conveying air pressure in such a way that a predetermined continuous operating pressure difference to the dosing air pressure is maintained in continuous operating mode and a predetermined emptying pressure difference to the dosing air pressure is maintained in emptying mode. In continuous operating mode, the spreading material is conveyed from the main distribution unit to the dosing systems essentially continuously. In emptying mode, the conveying of the spreading material from the main distribution unit to the dosing systems is reduced or interrupted, for example due to a completely emptied storage container or due to a flow-related interruption in the conveying of the spreading material from the main distribution unit to the dosing systems.

In a preferred embodiment, the material distribution system according to the invention has at least one conveying air pressure sensor, which is set up to determine the conveying air pressure. The conveying air pressure sensor can be arranged upstream of the main distribution unit or downstream of the main distribution unit in the direction of flow of the conveying air. The conveying air pressure sensor can also be arranged in the main distribution unit. The material distribution system can comprise several conveying air pressure sensors, for example two conveying air pressure sensors, whereby the determined conveying air pressure can be an average value from the sensor values of the conveying air pressure sensors. The conveying air pressure can be monitored by the control device or taken into account as part of a regulation routine when setting the conveying air pressure. The material distribution system can also have at least one dosing air pressure sensor, which is set up to determine the dosing air pressure. The dosing air pressure sensor is preferably arranged upstream of the dosing system in the direction of flow of the dosing air. The dosing air pressure sensor can also be arranged in a dosing system. The dosing air pressure sensor can also be arranged downstream of the dosing system in the direction of flow of the dosing air. The material distribution system can comprise several dosing air pressure sensors, for example two dosing air pressure sensors, whereby the determined dosing air pressure can be an average value from the sensor values of the dosing air pressure sensors.

In a further preferred embodiment of the material distribution system according to the invention, the dosing systems each comprise a pneumatic separating device, which is set up to be operated by means of a dosing air flow and to separate grains of the spreading material. The dosing air pressure sensor can be arranged in a separating device of the dosing system. Furthermore, the dosing air pressure sensor can be arranged in the direction of flow of the dosing air upstream or downstream of a separating device of a dosing system.

In a preferred embodiment of the material distribution system according to the invention, the dosing systems each have a material receiving unit which is set up to receive the spreading material provided via the conveying air flow and to temporarily store it before it is introduced into the separating device. The material receiving units are preferably set up to cause the interruption of the conveying air to the respective dosing system when a specific filling level of temporarily stored spreading material is reached.

A material distribution system according to the invention is also advantageous, in which the one or more blowers have a conveying air blower for generating the conveying air, wherein the control device is set up to control the conveying air blower for setting the conveying air pressure as a function of the dosing air pressure. The control device is preferably set up to adjust the conveying air pressure via the blower speed of the conveying air blower. Alternatively or additionally, the conveying air pressure can also be set via one or more air pressure control valves between the conveying blower and the main distribution unit or in the main distribution unit. Alternatively or additionally, the conveying air pressure can also be adjusted by setting the maximum supply air volume at the conveying air blower, for example by setting the opening state of a supply air opening. The opening state of the supply air opening can be set, for example, by means of one or more orifice bodies, such as lamellas.

Furthermore, a material distribution system according to the invention is preferred, in which the dosing systems are used for dosing seed and the material distribution system comprises a pneumatic fertilizer conveyor device, wherein the conveying air blower is set up to provide conveying air to the fertilizer conveyor device for conveying fertilizer. The conveying air blower thus serves to provide the conveying air for the conveying air flows and to provide the conveying air for fertilizer conveying.

In another preferred embodiment of the material distribution system according to the invention, the one or more blowers have a dosing air blower for generating the dosing air, wherein the control device is set up to control the dosing air blower to adjust the dosing air pressure. The control device is preferably set up to adjust the conveying air pressure in such a way that a predetermined pressure difference to the dosing air pressure is maintained. The pressure difference can be specified by the operator or by the control device.

In a preferred further development of the material distribution system according to the invention, the main distribution unit can be filled with spreading material from a storage container and the filling level of spreading material in the main distribution unit can be varied and can be monitored by means of a filling level sensor. The control device is set up to adjust the conveying air pressure in such a way that above a critical filling level of spreading material in the main distribution unit and when the critical filling level of spreading material in the main distribution unit is reached or below, pressure differences, which differ from one another and which are dependent on the filling level, to the dosing air pressure are maintained. The operating modes of the material distribution system can be assigned to a filling level or a filling level range of spreading material in the main distribution unit. The control device therefore ensures that the pressure difference to be maintained between the conveying air pressure and the dosing air pressure is adjusted if the filling level of spreading material in the main distribution unit falls below the critical filling level. The filling level sensor can be an emptying detector. The critical filling level can also relate to the complete emptying of the main distribution unit. The filling level can fall if the main distribution unit is fed with an insufficient amount of spreading material or the feeding of spreading material is interrupted, for example due to the storage container being completely empty. When the critical filling level is detected, a small pressure difference between the dosing air pressure and the conveying air pressure is set so that the conveying air pressure is reduced. In this way, it is avoided that material temporarily stored in the material receiving units of the dosing systems is pressed into the separating devices, which would interrupt or impair the separation due to a blockage of the separating device.

A material distribution system according to the invention is also preferred in which the one or more blowers comprise a common conveying and dosing blower for generating the conveying air and the dosing air, wherein the control device is arranged to divide an air dividing device connected to the conveying and dosing blower for dividing the air flow generated by the conveying and dosing blower into a conveying air main flow and a dosing air main flow. The conveying air main flow is fed to the main dividing unit so that no separate conveying air blower is required. The dosing air main flow is divided and then fed to the dosing systems so that no separate dosing air blower is required. The air dividing device can have a flap control. The conveying and dosing blower can also be set up to generate transport air for conveying a further spreading material, for example fertilizer. In this case, the air distribution device is set up, for example, to divide the air flow generated by the conveying and dosing blower into the conveying air main flow, the dosing air main flow and a transport air main flow. For example, the free flow cross-sections for the respective flows can be specified or set via the air distribution device. The air distribution device can be operated by an electric motor, for example via one or more electric motors, in particular electric linear motors.

In a further preferred embodiment of the material distribution system according to the invention, the control device is set up to adjust a predetermined pressure difference between the dosing air pressure and the conveying air pressure via the blower speed of the conveying and dosing blower and/or the free flow cross-section for the conveying air main flow in the air distribution device and/or the free flow cross-section for the dosing air main flow in the air distribution device. The free flow cross-section for the conveying air main flow and the free flow cross-section for the dosing air main flow can preferably be set independently of each other in the air distribution device.

In a further preferred embodiment, the material distribution system according to the invention has a plurality of deposit devices which are set up to deposit the spreading material dosed by the dosing systems on the agricultural area. The deposit devices each have at least one curved depositing line which is set up to guide the dosed spreading material along a curved material guide path in the direction of the agricultural area. The curved conveying line is preferably a curved shot pipe, whereby the curvature of the conveying line results in the spreading material guided through the conveying line coming into contact with the inner wall of the conveying line, so that compliance with the material guidance path is ensured.

A material distribution system according to the invention is also preferred, in which an interceptor element for intercepting the spreading material discharged in the direction of the agricultural area is arranged behind each of the deposit devices in the direction of travel. The interceptor elements can be interceptor rollers, for example. The conveying lines and the interceptor elements are preferably aligned with each other in such a way that the spreading material emerging from the conveying line is intercepted and immobilized between the soil of the agricultural area and the interceptor element. By using interceptor elements, precise placement of the spreading material on the agricultural area can also be ensured in overpressure dosing systems, for example dosing systems with overpressure separating, in which high material velocities form within the depositing line.

A material distribution system according to the invention is also advantageous, in which the depositing depth of the spreading material is adjustable and the control device is set up to adjust the dosing air pressure as a function of the set depositing depth. The depositing depth of the spreading material can, for example, be set via a depth control device for coulters of the material distribution system. At low sowing depths, it is advantageous to reduce the dosing air pressure, as otherwise the air speed in the deposit line becomes too high and the dosed spreading material can no longer be safely intercepted by the interceptor element.

The problem underlying the invention is further solved by a spreading machine of the type mentioned at the beginning, wherein the material distribution system of the spreading machine according to the invention is designed according to one of the embodiments described above. With regard to the advantages and modifications of the spreading machine according to the invention, reference is first made to the advantages and modifications of the material distribution system according to the invention.

The spreading machine can be a seed drill, a fertilizer spreading machine or a machine for the combined spreading of seed and fertilizer. The spreader can, for example, be a mounted machine or a self-propelled machine. If the spreading machine is a mounted machine, the spreading machine can be designed as a trailed or carried machine.

The problem on which the invention is based is further solved by a method of the type mentioned at the beginning, wherein the conveying pressure in the context of the method according to the invention is adjusted during a spreading operation in a plurality of different operating modes of the material distribution system by means of a control device of the material distribution system in a mode-specific manner as a function of the dosing air pressure. Preferably, the control device sets the conveying air pressure during the spreading process in the respective operating modes in such a way that a mode-specific predetermined pressure difference to the dosing air pressure is maintained in the respective operating modes. The mode-specific pressure differences differ from one another.

In a preferred embodiment of the method according to the invention, the material distribution system is operated in a continuous operating mode in which spreading material is supplied to the dosing systems from the main distribution unit. Furthermore, the material distribution system is operated in an emptying mode, in which the supply of spreading material to the dosing systems from the main distribution unit is reduced or interrupted compared to the continuous operating mode. Preferably, the control device adjusts the conveying air pressure in such a way that mode-specific pressure differences to the dosing air pressure, which differ from one another, are maintained in the continuous operating mode and in emptying mode.

In the following, preferred embodiments of the invention are explained and described in more detail with reference to the accompanying drawings. The drawings show:

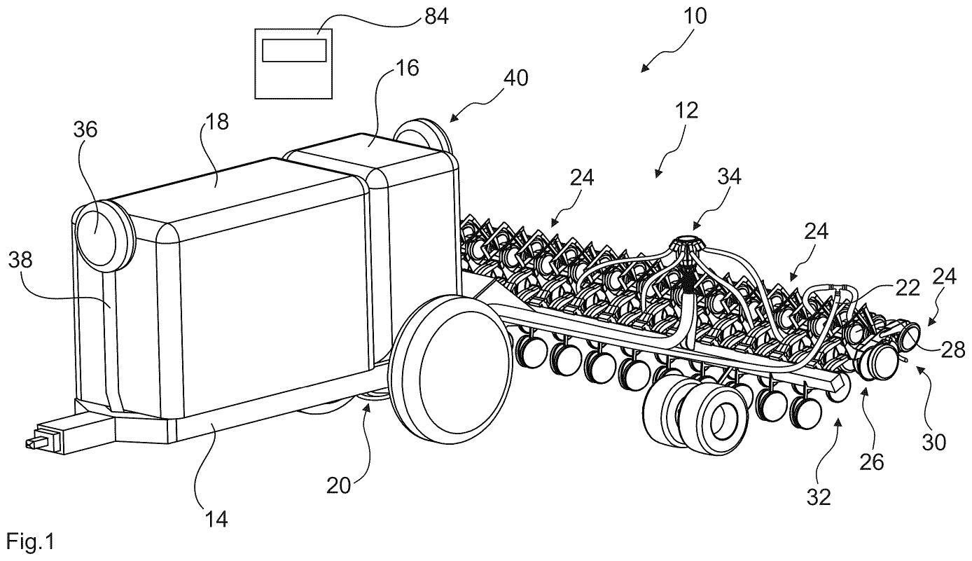

FIG. 1 a schematic representation of a spreading machine according to the invention;

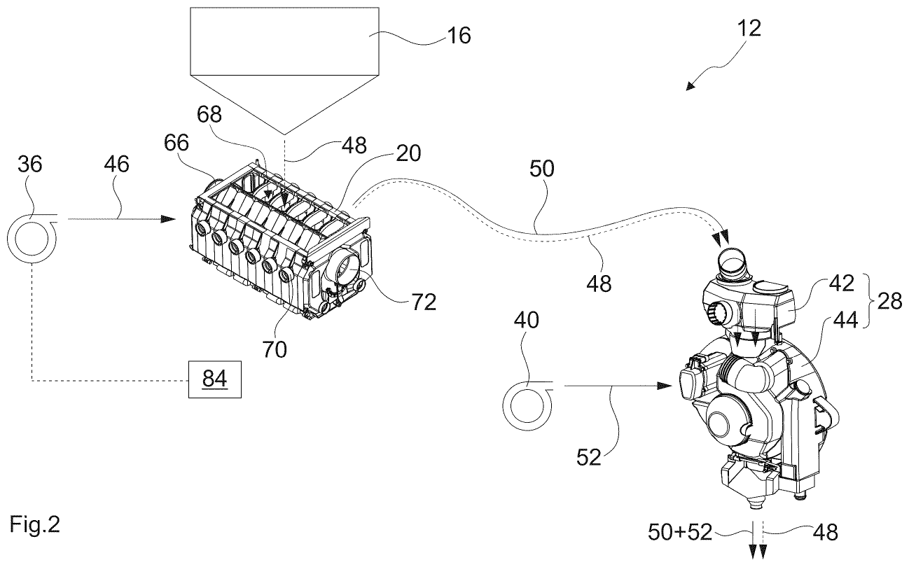

FIG. 2 a schematic representation of a material distribution system according to the invention;

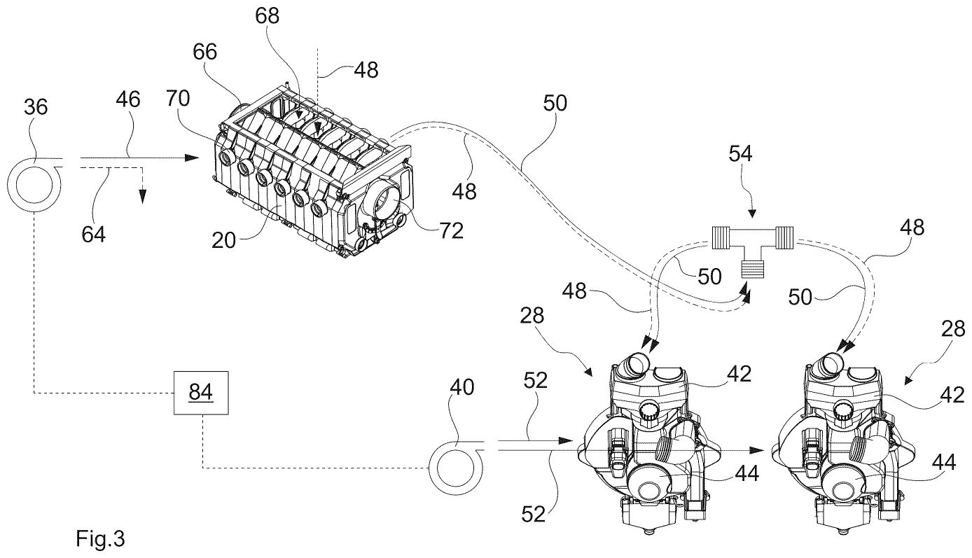

FIG. 3 a schematic representation of another material distribution system according to the invention;

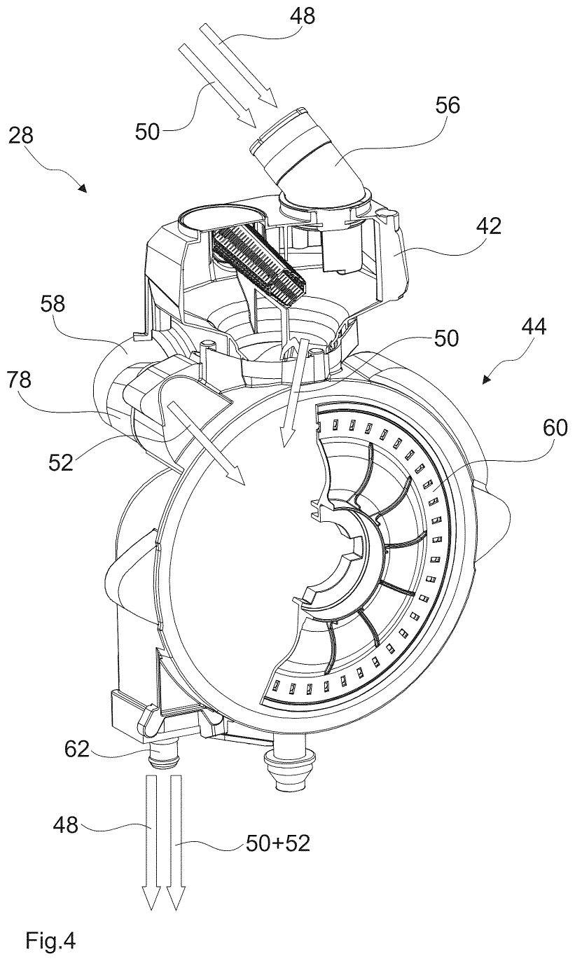

FIG. 4 a dosing system of a material distribution system according to the invention in a schematic sectional view;

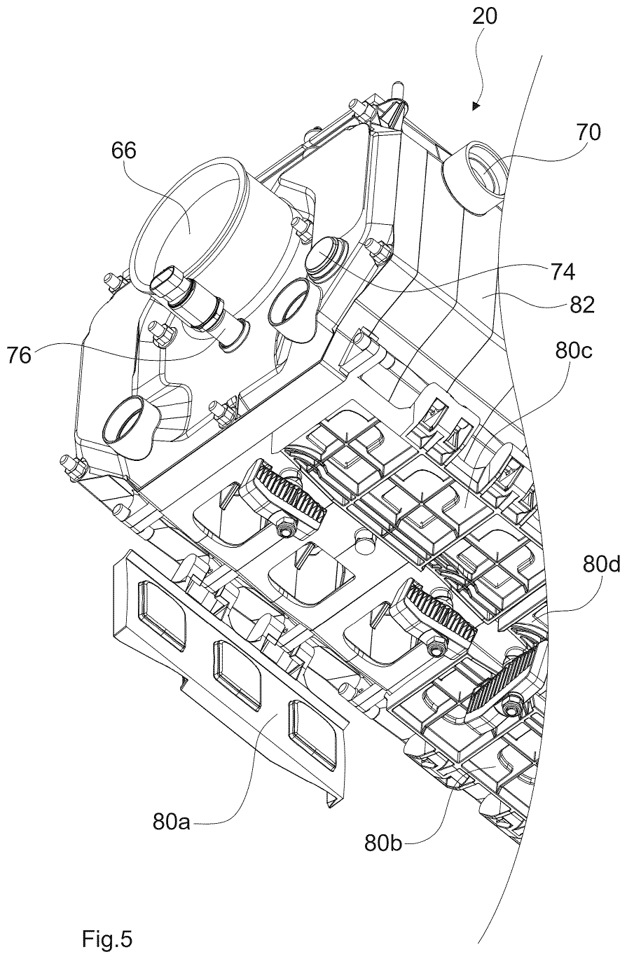

FIG. 5 an area of a main distribution unit of a material distribution system according to the invention in a perspective view from below; and

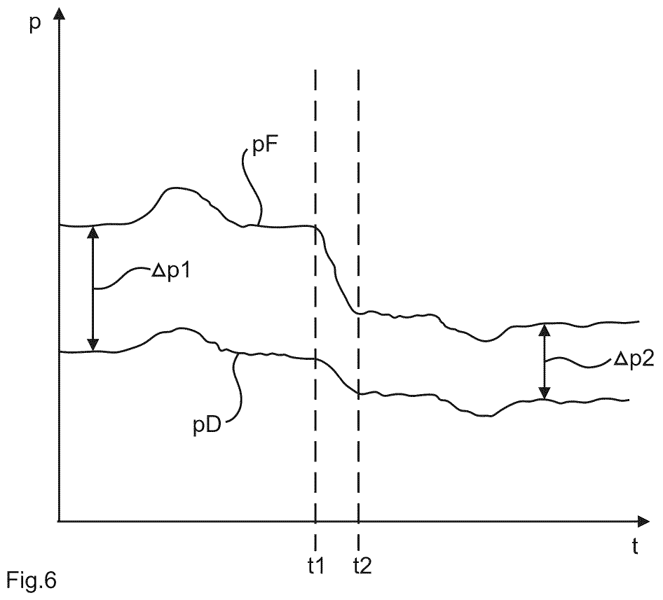

FIG. 6 changes in the conveying air pressure and the dosing air pressure during the execution of the method according to the invention.

FIG. 1 shows a spreading machine 10 designed as a large-area seed drill, by means of which seed and fertilizer can be spread simultaneously on an agricultural area.

The spreading machine 10 comprises a material distribution system 12 for distributing the spreading material within the machine.

The spreading machine 10 comprises a machine frame 14 on which two storage containers 16, 18 are arranged. The storage container 16 is used to store seed. The storage container 18 is used to store fertilizer, whereby the storage container 18 comprises two container units in which different types of fertilizer can be carried.

A main distribution unit 20 of the material distribution system 12 is located below the storage container 16. The main distribution unit 20 is used to generate several conveying air flows loaded with seed. The conveying air flows are fed to spreading units 24 of the spreading machine 10 via spreading lines 22. For the sake of clarity, only one spreading line 22 is shown, which supplies two spreading units 24 by means of a T-shaped distributor piece; of course, the remaining spreading units 24 are also supplied via analogous spreading lines 22. The spreading units 24 each comprise a sowing coulter 26, by means of which a depositing furrow for the seed is produced in the soil of the agricultural area. Furthermore, the spreading units 24 each comprise a dosing system 28, whereby the dosing systems 28 are each pneumatically operated with a flow of dosing air. The dosing systems 28 are used for dosing the seed conveyed into the dosing system 28 via the conveying air flows. The spreading units 24 further comprise deposit devices 30, via which the dosed seed is deposited in the depositing furrows produced by the sowing coulters 26.

The spreading units 24 further comprise fertilizer coulters 32, which serve to create a fertilizer depositing furrow. The fertilizer carried in the storage container 18 is conveyed via a fertilizer conveyor device 34 to the spreading units 24, from where it is deposited in the depositing furrows created by the fertilizer coulters 32.

The material distribution system 12 comprises a blower 36, which is used to generate the conveying air for the conveying air flows. The blower 36 is connected to the main distribution unit 20 of the material distribution system 12 via a conveying air main line 38. The blower 36 is also used to generate transport air for conveying the fertilizer to the spreading units 24.

The material distribution system 12 of the spreading machine 10 also comprises a blower 40, which is used to generate the dosing air for the dosing air flows. By means of the dosing air flows, the dosing systems 28 of the spreading units 24 can be pneumatically operated.

The material distribution system 12 further comprises a control device 84, which is set up to adjust the conveying air pressure of the conveying air during the spreading process in several different operating modes of the material distribution system 12 in a mode-specific manner as a function of the dosing air pressure of the dosing air. The control device 84 adjusts the conveying air pressure in the respective operating modes of the material distribution system 12 such that a predetermined mode-specific pressure difference to the dosing air pressure is maintained in the respective operating modes, whereby the dosing air pressure serves as a reference variable in the respective operating modes.

FIG. 2 shows a material distribution system 12 for an agricultural spreading machine 10. The material distribution system 12 comprises a blower 36, which generates a conveying air main flow 46. The conveying air main flow 46 is fed to the main distribution unit 20 via a conveying air main line. The conveying air main line is connected to the air inlet 66 of the main distribution unit 20. Excess air can be discharged into the environment via the adjustable air outlet 72.

A storage container 16 for the spreading material 48 is located above the main distribution unit 20. The spreading material 48 can be seed, for example. The main distribution unit 20 has a material inlet opening 68, via which the spreading material 48 falls into the main distribution unit 20 under the effect of gravity. A plurality of conveying air flows 50 loaded with the spreading material 48 are generated within the main distribution unit 20, which are discharged from the main distribution unit 20 via the outlets 70. The conveying air flows 50 loaded with spreading material 48 are fed to several dosing systems 28 via discharge lines, whereby an example of a dosing system 28 is shown in FIG. 2. The dosing system 28 is pneumatically operated by means of a dosing air flow 52 generated by the blower 40 and is used for dosing the spreading material 48 conveyed into the dosing system 28 via the conveying air flow 50 before it is deposited on the agricultural area. The dosing system 28 comprises a material receiving unit 42 and a separating device 44. The material receiving unit 42 is set up to receive the spreading material 48 provided via the conveying air flow 50 and to temporarily store it before it is introduced into the separating device 44. Furthermore, the material receiving unit 42 is set up to cause the interruption of the conveying air flow 50 to the dosing system 28 when a specific filling level of temporarily stored spreading material 48 is reached. The separating device 44 is a pneumatically operated separating device which operates according to the principle of overpressure separation. The separating device 44 is set up to be operated by means of the dosing air flow 52 and to separate grains of the spreading material 48.

The material distribution system 12 further comprises a control device 84, which is set up to adjust the conveying air pressure of the conveying air for the conveying air flows 50 during a spreading process in several different operating modes of the material distribution system 12 in a mode-specific manner as a function of the dosing air pressure of the dosing air for the dosing air flows 52.

The material distribution system 12 can be operated in a continuous operating mode and in an emptying mode. In the continuous operating mode, spreading material 48 is fed to the dosing systems 28 from the main distribution unit 20. In the emptying mode, the supply of spreading material 48 to the dosing systems 28 from the main distribution unit 20 is reduced or interrupted compared to the continuous operating mode. The control device 84 adjusts the conveying air pressure in such a way that mode-specific pressure differences, which differ from one another, from the dosing air pressure are maintained in the continuous operating mode and in the emptying mode. The control device sets the conveying air pressure in such a way that a specified continuous operating pressure difference to the dosing air pressure is maintained in continuous operating mode and a specified emptying pressure difference to the dosing air pressure is maintained in emptying mode.

FIG. 3 shows an alternative embodiment of the material distribution system 12, in which the outlets 70 of the main distribution unit 20 are initially connected to a flow divider 54, whereby the flow divider 54 splits the conveying air flow 50 loaded with spreading material 48, so that two dosing systems 28 can be fed via one outlet 70 on the main distribution unit 20. The blower 40 provides the dosing air flows 52 for the dosing systems 28.

The blower 36 also generates a further conveying air main flow 64, via which fertilizer can be transported to the spreading units 24 of the spreading machine 10.

FIG. 4 shows a dosing system 28 of a material distribution system 12. The dosing system 28 comprises a material receiving unit 42 and a separating device 44. The conveying air flow 50 loaded with spreading material 48 is introduced into the material receiving unit 42 via the inlet nozzle 56. The material receiving unit 42 serves to receive and temporarily store the spreading material 48 conveyed by the conveying air flow 50.

The separating device 44 is a pneumatic separating device which operates according to the principle of overpressure separating. The separating device 44 comprises a separation disk 60, wherein the separation disk 60 has a plurality of grain receiving pockets for receiving and discharging separated grains. In alternative embodiments, the separating device 44 may also comprise a separating drum instead of a separating disk, for example.

The dosing air flow 52 for operating the separating device 44 enters the dosing system 28 via the inlet nozzle 58. The dosed spreading material 48 is then discharged from the dosing system 28 via the outlet nozzle 62 in the form of separated seeds and fed to a deposit device 30. The deposit device 30 has a curved depositing line and is set up to deposit the spreading material 28 dosed by the dosing system 28 on the agricultural area.

The dosing system 28 comprises a dosing air pressure sensor 78, which is arranged to determine the dosing air pressure of the dosing air of the dosing air flow 52. In alternative embodiments, the dosing air pressure sensor 78 may also be arranged upstream of the dosing system 28 in the direction of flow of the dosing air.

FIG. 5 shows the housing 82 of a main distribution unit 20. The main distribution unit 20 comprises a conveying air pressure sensor 76, which is set up to determine the conveying air pressure. In other embodiments, the conveying air pressure sensor 76 can also be arranged upstream of the main distribution unit 20 or downstream of the main distribution unit 20 in the direction of flow of the conveying air.

The main distribution unit 20 can be filled with spreading material 48 from a storage container 16, wherein the filling level of spreading material 48 in the main distribution unit 20 can be monitored by means of a filling level sensor 74. The control device 84 is set up to adjust the conveying air pressure of the conveying air in such a way that above a critical filling level of spreading material 48 in the main distribution unit 20 and when the critical filling level of spreading material 48 in the main distribution unit 20 is reached or below, filling level-dependent pressure differences, which differ from one another, to the dosing air pressure are maintained.

Furthermore, the housing 82 of the main distribution unit 20 comprises discharge flaps 80a-80d, via which the main distribution unit 20 can be emptied, for example after completion of a spreading operation.

FIG. 6 shows an example of the pressure curves of the conveying air pressure pF and the dosing air pressure pD during a spreading process using a material distribution system 12. Up to time point t1, the material distribution system 12 is operated in a first operating mode in which the control device 84 sets the conveying air pressure pF in such a way that a mode-specific pressure difference Δp1 to the dosing air pressure pD is maintained. The dosing air pressure pD serves as a reference variable. The dosing air pressure pD changes slightly up to time point t1, for example because the spreading machine detects temporary changes in the spreading material 48 and these require the adjustment of the dosing air pressure pD.

At time point t1, a second operating mode of the material distribution system 12 is set, whereby the control device 84 sets a lower dosing air pressure pD and a lower pressure difference Δp2 between the dosing air pressure pD and the conveying air pressure pF in the second operating mode of the material distribution system 12. The setting of the new mode-specific dosing air pressure pD and the mode-specific pressure difference Δp2 are completed at time point t2.

For example, the control device 84 has determined a dosing air pressure pD to be maintained and a pressure difference Δp2 by comparing it with the remaining area of agricultural area still to be worked, which results in the material receiving units 42 of the dosing systems 28 being completely emptied at the end of the spreading process.

### REFERENCE SIGNS

10 Spreading machine
12 Material distribution system
14 Machine frame
16 Storage container
18 Storage container
20 Main distribution unit
22 Spreading lines
24 Spreading units
26 Sowing coulters
28 Dosing systems
30 Deposit devices
32 Fertilizer coulter
34 Fertilizer conveyor device
36 Blower
38 Conveying air main line
40 Blower
42 Material receiving unit
44 Separating device
46 Conveying air main flow
48 Spreading material
50 Conveying air flow
52 Dosing air flow
54 Flow divider
56 Inlet nozzle
58 Inlet nozzle
60 Separation disk
62 Outlet nozzle
64 Conveying air main flow
66 Air inlet
68 Material inlet opening
70 Outlets
72 Air outlet
74 Filling level sensor
76 Conveying air pressure sensor
78 Dosing air pressure sensor
80a-80d Discharge flaps
82 Housing
84 Control device
pF Conveying air pressure
pD Dosing air pressure
t1, t2 Time points
Δp1, Δp2 Pressure differences

1. Material distribution system (12) for an agricultural spreading machine (10), with
a main distribution unit (20) for generating a plurality of conveying air flows (50) loaded with spreading material (48);
a plurality of dosing systems (28), each of which is adapted to be pneumatically operated by means of a dosing air flow (52) and to dose the spreading material (48) conveyed into the dosing system (28) via one of the conveying air flows (50); and
one or more blowers (36, 40), which are set up to generate the conveying air having a conveying air pressure (pF) for the conveying air flows (50) and the dosing air having a dosing air pressure (pD) for the dosing air flows (52);
characterized by a control device (84) which is set up to adjust the conveying air pressure (pF) during a spreading process in several different operating modes of the material distribution system (12) in a mode-specific manner as a function of the dosing air pressure (pD).

2. Material distribution system (12) according to claim 1, characterized in that the material distribution system (12) can be operated in a continuous operating mode, in which the dosing systems (28) are supplied with spreading material (48) from the main distribution unit (20), and in an emptying mode, in which the supply of spreading material (48) to the dosing systems (28) from the main distribution unit (20) is reduced or interrupted in comparison to the continuous operating mode,
wherein the control device (84) is set up to adjust the conveying air pressure (pF) in such a way that mode-specific pressure differences (Δp1, Δp2) from the dosing air pressure (pD) are maintained in the continuous operating mode and emptying mode.

3. Material distribution system (12) according to claim 1 or 2, characterized by
at least one conveying air pressure sensor (76), which is set up to determine the conveying air pressure (pF); and/or
at least one dosing air pressure sensor (78), which is set up to determine the dosing air pressure (pD).

4. Material distribution system (12) according to one of the preceding claims, characterized in that the one or more blowers (36, 40) have a conveying air blower (36) for generating the conveying air, wherein the control device (84) is set up to control the conveying air blower (36) for setting the conveying air pressure (pF) as a function of the dosing air pressure (pD).

5. Material distribution system (12) according to claim 4, characterized in that the dosing systems (28) are used for dosing seed and the material distribution system (12) comprises a pneumatic fertilizer conveyor device (34), wherein the conveying air blower (36) is set up to provide conveying air to the fertilizer conveyor device (34) for conveying fertilizer.

6. Material distribution system (12) according to one of the preceding claims, characterized in that the main distribution unit (20) can be filled with spreading material (48) from a storage container (16) and the filling level of spreading material (48) in the main distribution unit (20) can be varied and can be monitored by means of a filling level sensor (74),
wherein the control device (84) is set up to adjust the conveying air pressure (pF) in such a way that above a critical filling level of spreading material (48) in the main distribution unit (20) and when the critical filling level of spreading material (48) in the main distribution unit (20) is reached or below, pressure differences (Δp1, Δp2), which differ from one another and which are dependent on the filling level, to the dosing air pressure (pD) are maintained.

7. Material distribution system (12) according to one of the preceding claims, characterized by a plurality of deposit devices (30) which are set up to deposit the spreading material (48) dosed by the dosing systems (28) on the agricultural area, wherein the deposit devices (30) each have at least one curved depositing line which is set up to guide the dosed spreading material (48) along a curved material guide path in the direction of the agricultural area.

8. Material distribution system (12) according to claim 7, characterized in that an interceptor element for intercepting the spreading material (48) discharged in the direction of the agricultural area is arranged behind each of the deposit devices (30) in the direction of travel.

9. Material distribution system (12) according to one of the preceding claims, characterized in that the depositing depth of the spreading material (48) is adjustable and the control device (84) is set up to adjust the dosing air pressure (pD) as a function of the set depositing depth.

10. Spreading machine (10) for spreading spreading material (48) on an agricultural area, with
a storage container (16) for the spreading material (48);
several spreading units, and
a material distribution system (12) for distributing the spreading material (48) from the storage container (16) to the multiple spreading units;
characterized in that the material distribution system (12) is designed according to one of the preceding claims.

11. Method for distributing spreading material (48) from a storage container (16) to a plurality of spreading units of a spreading machine (10) by means of a material distribution system (12), in particular a material distribution system (12) according to one of claims 1 to 9, comprising the steps of:
Generating a plurality of conveying air flows (50) loaded with spreading material (48) by means of a main distribution unit (20) of the material distribution system (12);
supply of conveying air flows (50) loaded with spreading material (48) to pneumatically operated dosing systems (28) of the material distribution system (12);
dosing the spreading material (48) conveyed via the conveying air flows (50) to the dosing systems (28) by means of the dosing systems; and
generating the conveying air having a conveying air pressure (pF) for the conveying air flows (50) and the dosing air having a dosing air pressure (pD) for the dosing air flows (52) by means of one or more blowers (36, 40) of the material distribution system (12);
characterized in that the conveying air pressure (pF) is adjusted during a spreading operation in a plurality of different operating modes of the material distribution system (12) by means of a control device (84) of the material distribution system (12) in a mode-specific manner as a function of the dosing air pressure (pD).

12. Method according to claim 10, characterized by the following steps:
Operating the material distribution system (12) in a continuous operating mode in which spreading material (48) is supplied to the dosing systems (28) from the main distribution unit (20), and
operating the material distribution system (12) in an emptying mode, in which the supply of spreading material (48) to the dosing systems (28) from the main distribution unit (20) is reduced or interrupted compared to the continuous operating mode,
wherein the control device (84) adjusts the conveying air pressure (pF) in such a way that mode-specific pressure differences (Δp1, Δp2) to the dosing air pressure (pD), which differ from one another, are maintained in the continuous operating mode and in emptying mode.
